(19) United States
(12) Patent Application Publication
(10) Pub. No.: US 2026/0104868 A1
(43) Pub. Date: Apr. 16, 2026

(54) System and Method for Predicting Dependency Patterns and Behaviors of Software Applications to Optimize Code Remediation

(71) Applicant: Bank of America Corporation, Charlotte, NC (US)

(72) Inventors: Nipun Mahajan, Lawrenceville, NJ (US); Krithika Viswanathan, Chennai (IN); Amit Mishra, Chennai (IN); Srikanth Janardhan Rao, Hyderabad (IN); Shiva Prasad S, Chennai (IN); Yogesh Raghuvanshi, Pennington, NJ (US); Sushil Golani, Waxhaw, NC (US)

(21) Appl. No.: 18/914,743

(22) Filed: Oct. 14, 2024

(51) Int. Cl. G06F 8/41; G06F 11/36

(52) U.S. Cl. CPC G06F 8/433; G06F 11/3612

(57) ABSTRACT

A system includes a memory configured to store a software codebase of a software application and a processor operably coupled to the memory and configured to access the software codebase of the software application, identify, based on the software codebase, relationships between the plurality of software application components, and extract, based on the identified relationships between the plurality of software application components, a set of features representative of a runtime environment associated with an execution of the software application. The processor is further configured to execute, based on the extracted set of features, one or more machine-learning models trained to generate a prediction of dependencies of each of the plurality of software application components on one or more other software application components. The prediction of the dependencies includes an identification of one or more of the plurality of software application components likely to experience a downtime during a remediation.

### TECHNICAL FIELD

The present disclosure relates generally to computing security, and, more specifically, to a system and method for predicting dependency patterns and behaviors of software applications to optimize code remediation.

### BACKGROUND

A software development life cycle (SDLC) generally includes a phase-by-phase process or project management and development framework utilized by software development teams to design and build useful software applications and systems. For example, a typical SDLC may include a planning phase, a design phase, a development phase, a testing phase, a deployment phase, and a maintenance phase. In many instances, after software applications or systems are deployed, one or more software code changes may be requested and executed by software developers. However, some software code changes may have an adverse cascading impact to certain components of a software application or software system unintended to be changed.

### SUMMARY

The system and methods implemented by the system as disclosed in the present disclosure provide technical solutions to the technical problems discussed above by providing systems and methods for predicting dependencies and behaviors of software applications to optimize software code remediation. The disclosed system and methods provide several practical applications and technical advantages. Specifically, the present embodiments improve the maintainability, reliability, and security of software applications, systems, and services, as well as the one or more processors and memory on which the software applications, systems, and services may be executed and stored by autonomously identifying, prioritizing, and deploying software code patches to remediate vulnerabilities of a software application based on predictions of the dependencies between various software application components of the software application and the simulated behaviors of the software application under real-time or near real-time application environment conditions.

Thus, the present embodiments may improve patch management workflows during the maintenance phase of the software development life cycle (SDLC), and thereby mitigate the potential for any protracted software application downtimes, software application faults, software application outages, or other systemic vulnerabilities that may be associated with software applications, systems, and networks over time following deployment. Additionally, by autonomously identifying, prioritizing, and deploying software code patches to remediate vulnerabilities based on predictions of the dependencies between various software application components of the software application and the simulated behaviors of the software application under real-time or near real-time application environment conditions, the present embodiments may further efficiently allocate the processing workloads of the one or more processors and the storage capacity of the memory. In particular, the present embodiments may further efficiently allocate the processing workloads of the one or more processors and the storage capacity of the memory because the one or more processors and the memory may be programmably configured to iteratively execute only those software application components not currently undergoing remediation (e.g., patching) and forgoing executing those software application components currently undergoing remediation (e.g., patching) per cycle.

In this way, the present embodiments allow the one or more processors and memory to execute the software application components of the software application and remediations (e.g., patching) of the software application components in accordance with a zero downtime (ZDT) code remediation algorithm so as to prevent the overall software application from experiencing a protracted downtime or unnecessary service interruption (e.g., such as the case when a processor generally attempts to execute a software application or software application component undergoing remediation). Lastly, by autonomously identifying, prioritizing, and deploying software code patches to remediate vulnerabilities based on predictions of the dependencies between various software application components of the software application and the simulated behaviors of the software application under real-time or near real-time application environment conditions, the present embodiments may further extend the lifespan of software applications, systems, and services.

The present embodiments are directed to systems and methods for predicting dependencies and behaviors of software applications to optimize software code remediation. In particular embodiments, a system includes a memory configured to store a software codebase of at least one software application. In one embodiment, the at least one software application may include a plurality of software application components. In particular embodiments, the plurality of software application components may include one or more of a user portal component, a validator component, an activity component, an authentication component, a secure documentation component, or a third-party application component.

In particular embodiments, the system may further include one or more processors operably coupled to the memory and configured to access the software codebase of the at least one software application. In particular embodiments, the one or more processors may be further configured to identify, based at least in part on the software codebase, one or more relationships between the plurality of software application components. For example, in particular embodiments, the one or more processors may be configured to identify the one or more relationships between the plurality of software application components by receiving a real-time or near real-time data stream during the execution of the at least one software application.

In particular embodiments, the one or more processors may be further configured to extract, based at least in part on the identified one or more relationships between the plurality of software application components, a set of features representative of a runtime environment associated with an execution of the at least one software application. For example, in particular embodiments, the one or more processors may be configured to extract a set of most predictive features representative of the runtime environment associated with the execution of the at least one software application. In particular embodiments, prior to executing the one or more machine-learning models, the one or more processors may be further configured to combine the set of most predictive features representative of the runtime environment into a combined feature data set for input to the one or more machine-learning models.

In particular embodiments, the one or more processors may be further configured to execute, based at least in part on the extracted set of features, one or more machine-learning models trained to generate a prediction of one or more dependencies of each of the plurality of software application components on one or more other software application components of the plurality of software application components. In one embodiment, the prediction of the one or more dependencies may include an identification of one or more of the plurality of software application components likely to experience a downtime during a remediation of the one or more other software application components. For example, in particular embodiments, the one or more machine-learning models may include one or more of a neuromorphic image compression (NIC) model, a spiking neural network (SNN), an autoencoder (AE), a variational autoencoder (VAE), a generative adversarial network (GAN), or a bidirectional generative adversarial network (BiGAN).

In particular embodiments, prior to executing the one or more machine-learning models, the one or more processors may be further configured to combine the set of most predictive features representative of the runtime environment into a combined feature data set for input to the one or more machine-learning models. In particular embodiments, the one or more processors may be further configured to execute the one or more machine-learning models further trained to generate the prediction of the one or more dependencies based at least in part on the combined feature data set. In particular embodiments, the one or more processors may be further configured to output, by the one or more machine-learning models, the prediction of the one or more dependencies of each of the plurality of software application components.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an integrated software remediation management and deployment system, in accordance with certain aspects of the present disclosure;

FIGS. 2A and 2B illustrate a workflow diagram of an embodiment of an integrated software remediation management and deployment system for predicting dependencies and behaviors of software applications to optimize software code remediation, in accordance with one or more embodiments of the present disclosure;

FIG. 3 illustrates a flowchart of an example method for predicting dependencies and behaviors of software applications to optimize software code remediation, in accordance with one or more embodiments of the present disclosure; and

FIG. 4 illustrates a flowchart of an example method for dynamically updating software code remediation workflows based on dependencies and behaviors of software applications, in accordance with one or more embodiments of the present disclosure.

### DETAILED DESCRIPTION

### Example System

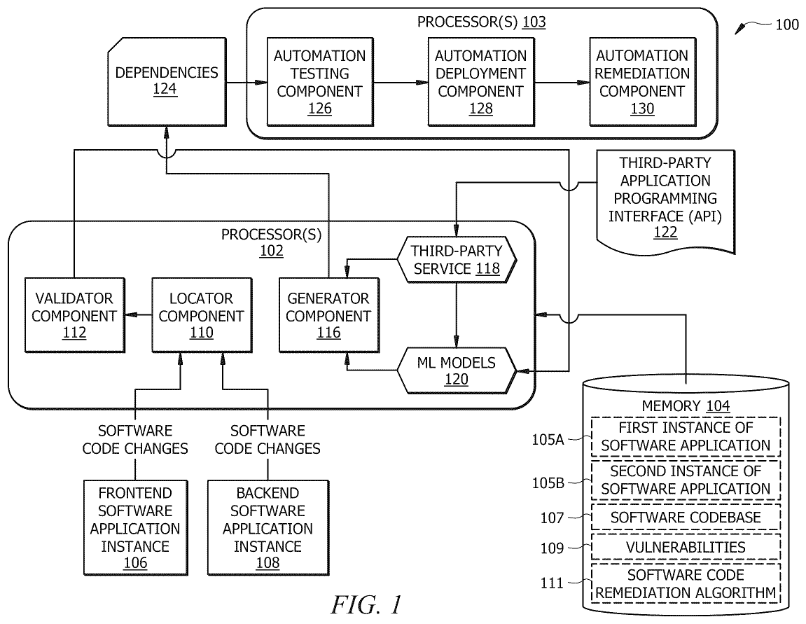

FIG. 1 is a schematic diagram of an integrated software remediation management and deployment system 100 for predicting dependencies and behaviors of software applications to optimize software code remediation, in accordance with certain aspects of the present disclosure. As depicted, the integrated software remediation management and deployment system 100 may include one or more processors 102 and a memory 104, which may be utilized in conjunction to generate predictions of dependencies and behaviors of the software application 106, 108 to optimize code remediation in accordance with the presently disclosed embodiments.

Additionally, the integrated software remediation management and deployment system 100 may further include one or more processors 103, which may be utilized to dynamically update software code remediation workflows based on dependencies and behaviors of the software application 106, 108 in accordance with the presently disclosed embodiments. In one embodiment, the one or more processors 102 may be included as part of a centralized server and may be utilized to generate a prediction of one or more dependencies 124 of the software application 106, 108. In one embodiment, the one or more processors 103 may be included as part of one or more downstream computing systems on the same computing network as the one or more processors 102 and may be utilized to execute and deploy one or more remediations (e.g., patching) to the software application 106, 108.

In particular embodiments, the one or more processors 102 may be operably coupled to the memory 104 and the one or more processors 103 may be operably coupled to the memory 104. For example, the one or more processors 102, 103 may include any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). In some embodiments, the one or more processors 102 may be a programmable logic device, a microcontroller, a microprocessor, or any suitable combination of the preceding.

The one or more processors 102, 103 may be further communicatively coupled to and in signal communication with the memory 104. The one or more processors may be configured to process data and may be implemented in hardware or software. For example, the one or more processors 102, 103 may be 8-bit, 16-bit, 32-bit, 64-bit or of any other suitable architecture. The one or more processors 102 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors 102, 103 may be further configured to implement various instructions. For example, the one or more processors 102, 103 may be configured to execute instructions stored by the memory 104. In such instances, the one or more processors 102, 103 may be a special-purpose computer designed to implement and execute the functions disclosed herein.

The memory 104 may include one or more disks, tape drives, or solid-state drives, and may be used as an over-flow data storage device, to store programs when such programs are selected for execution, and to store instructions and data that are read during program execution. The memory 104 may be volatile or non-volatile and may include a read-only memory (ROM), random-access memory (RAM), ternary content-addressable memory (TCAM), dynamic random-access memory (DRAM), static random-access memory (SRAM), and so forth. In one embodiment, the memory 104 may include a non-transitory computer-readable medium. As further depicted by the integrated software remediation management and deployment system 100 of FIG. 1, in particular embodiments, the memory 104 may be operable to store a first instance of the software application 105A and a second instance of the software application 105B.

For example, in one embodiment, the first instance of the software application 105A may include a frontend of a software application 106 and the second instance of the software application 105B may include a backend of a software application 108. While the frontend of the software application 106 and backend of the software application 108 may be labeled as a “frontend” and “backend,” respectively, it should be appreciated that the backend of the software application 108 may include any instance of a software application, a software system, or a software service on which the frontend of the software application 106 may be dependent.

The memory 104 may be further operable to store a software codebase 107 or any number of software codebases 107. For example, in one embodiment, the software codebase 107 may include a comprehensive source code for a software application implemented, for example, as the frontend of the software application 106 and the backend of the software application 108. In particular embodiments, the software codebase 107 may be accessed by the one or more processors 102 in response to a request by one or more software developers or software engineers associated with the design, implementation, testing, deployment, and maintenance of one or more of the frontend of the software application 106 or the backend of the software application 108.

The memory 104 may be further operable to store a software code remediation algorithm 111 that may be associated with remediating one or more instances of vulnerabilities 109 associated with the software codebase 107. For example, in accordance with the presently disclosed embodiments, the software code remediation algorithm 111 may include a patching workflow algorithm that may be suitable for remediating (e.g., patching) the one or more instances of vulnerabilities 109 associated with the software codebase 107 without the software application 106, 108 experiencing a downtime. In particular embodiments, the one or more processors 103 may access, execute, and deploy the software code remediation algorithm 111.

In particular embodiments, the one or more processors 102 may access and scan the software codebase 107 to identify and extract an instance of one or more of vulnerabilities 109 (e.g., security vulnerability, design flaw, or other vulnerability) within the software codebase 107. For example, in one embodiment, the one or more processors 102 may execute a static application security testing (SAST) scan of the software codebase 107, in which the SAST scan of the software codebase 107 may be executed during one or more of an implementation phase of the software application corresponding to the software codebase 107, a development phase of the software application corresponding to the software codebase 107, a testing phase of the software application corresponding to the software codebase 107, or a maintenance phase of the software application corresponding to the software codebase 107.

As further depicted by the integrated software remediation management and deployment system 100 of FIG. 1, the one or more processors 102 may include a locator component 110, a validator component 112, and a generator component 116. Although these components 110, 112, and 116 are illustrated as separate components, they may be implemented in any suitable number and combination of components to suitable particular tasks of the integrated software remediation management and deployment system 100. The locator component 110 may identify any changes to the software codebase 107 that may be associated with the frontend of the software application 106 or the backend of the software application 108. The locator component 110 may then provide the changes to the software codebase 107 to the validator component 112.

As further depicted by the integrated software remediation management and deployment system 100 of FIG. 1, the validator component 112 may provide any changes to the software codebase 107 that may be associated with one or more of the frontend of the software application 106 or the backend of the software application 108 to one or one or more machine-learning models 120. Similarly, a third-party service 118 executing on the one or more processors 102 may access any changes or impacts to the software codebase 107 that may be associated with a third-party application programming interface (API) 122.

In particular embodiments, as further depicted by FIG. 1, the one or more processors 102 may execute the one or more machine-learning models 120 that may be utilized to generate a prediction of one or more dependencies 124, which may include an identification of one or more software application components of the software application 106, 108 likely to experience a downtime during a remediation (e.g., patching) of one or more dependent software application components of the software application 106, 108. In one embodiment, the generator component 116 may execute the one or more machine-learning models 120 to generate the one or more dependencies 124.

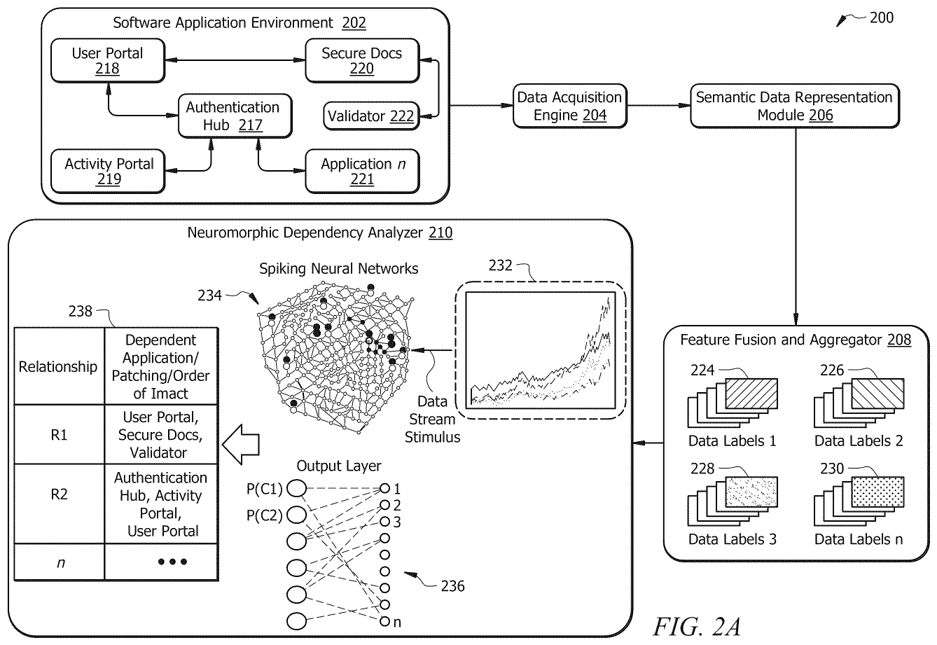

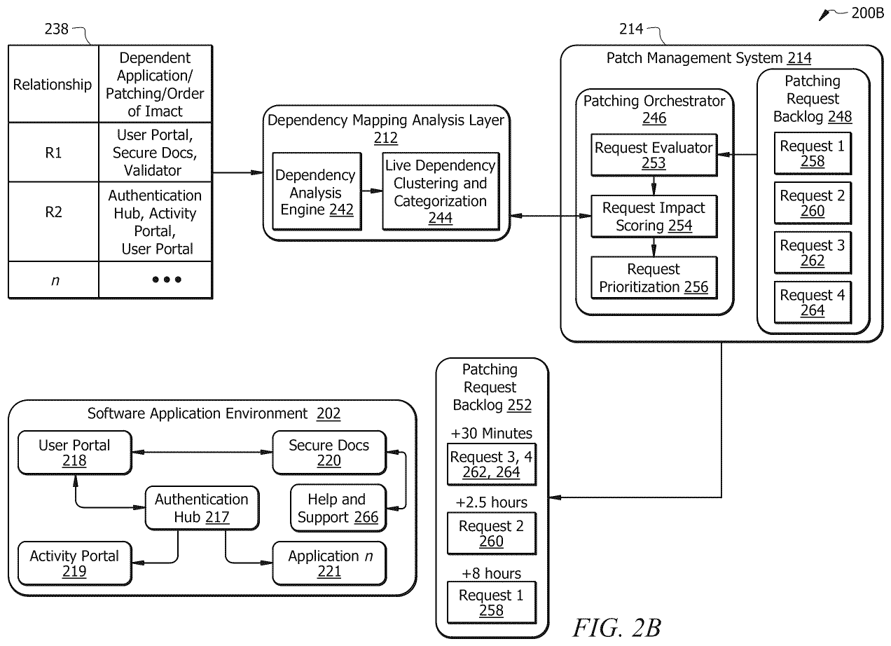

As will be discussed in greater detail below with respect to FIGS. 2A and 2B, in accordance with the presently disclosed embodiments, the one or more machine-learning models 120 may include one or more of a neuromorphic image compression (NIC) model, a spiking neural network (SNN), an autoencoder (AE), a variational autoencoder (VAE), a generative adversarial network (GAN), or a bidirectional generative adversarial network (BiGAN) that may be suitably trained for generating a prediction of one or more dependencies 124 of the software application 106, 108.

In particular embodiments, the generator component 116 may then provide the prediction of one or more dependencies 124 to one or more of an automation testing component 126, an automation deployment component 128, or an automation remediation component 130. For example, the automation testing component 126, the automation deployment component 128, or the automation remediation component 130 may be utilized to test and validate, deploy, and/or remediate (e.g., patch) the software codebase 107 in accordance with the prediction of one or more dependencies 124. In one embodiment, the automation remediation component 130 may be utilized to remediate (e.g., patch) the software codebase 107 by executing and deploying the software code remediation algorithm 111.

### Predicting Dependencies and Behaviors of Software Applications to Optimize Software Code Remediation

Embodiments of the present disclosure discuss techniques for predicting dependencies and behaviors of software applications to optimize software code remediation.

FIGS. 2A and 2B illustrate a workflow diagram of an embodiment of an integrated software remediation management and deployment system 200A, 200B for predicting dependencies and behaviors of software applications to optimize software code remediation, in accordance with certain aspects of the present disclosure. As used herein, a “remediation” or a “software code remediation” may refer to any process of identifying vulnerabilities, weaknesses, or design flaws in software applications, systems, or services and then executing one or more appropriate actions (e.g., a “rip and replace” of the code associated with the vulnerability, a patching of the code associated with the vulnerability, an automatic generation of remediation code, and so forth) suitable for resolving the identified vulnerabilities, weaknesses, or design flaws.

Additionally, as used herein, a “dependency” or “dependent application” may refer to any software application, microservice, software applet, software plugin, software driver, or other similar application in which an execution thereof may be interrupted or otherwise adversely impacted (e.g., by way of a protracted downtime, a service outage, and so forth) during a time period in which an associated software application, microservice, software applet, software plugin, software driver, or other similar application undergoes one or more remediations (e.g., patching).

In particular embodiments, the workflow of the integrated software remediation management and deployment system 200A, 200B may be performed utilizing the one or more processors 102 as described above with respect to FIG. 1. Furthermore, it should be appreciated that each component (e.g., one or more engines, modules, layers, and so forth) illustrated as part of the integrated software remediation management and deployment system 200A, 200B may include a software engine or module that may be implemented and executed on the one or more processors 102 or the one or more processors 103.

For example, as depicted by FIGS. 2A and 2B, the integrated software remediation management and deployment system 200A, 200B may include software application and application components 202, a data acquisition engine 204, a semantic data representation module 206, a feature fusion and aggregator 208, a neuromorphic dependency analyzer 210, and a dependency mapping analysis layer 212 that may be each implemented and executed, in some embodiments, on the one or more processors 102. Similarly, as further depicted by FIGS. 2A and 2B, the integrated software remediation management and deployment system 200A, 200B may include patch management system 214 and updated patching request backlog 252 that may be each implemented and executed, in some embodiments, on the one or more processors 103.

In particular embodiments, the workflow of the integrated software remediation management and deployment system 200A, 200B may begin with accessing software application and application components 202. Specifically, in one embodiment, a software codebase representative of an implementation of the software application and application components 202 may be accessed. In particular embodiments, the software application and application components 202 may include, for example, one or more of an authentication component 217, a user portal component 218, an activity component 219, a secure documentation component 220, one or more third-party or ancillary application components 221, a validator component 222, or similar application component that may be included as part of a larger software application, software service, or software system.

In particular embodiments, the workflow of the integrated software remediation management and deployment system 200A, 200B may continue with the data acquisition engine 204 receiving a real-time or near real-time data stream during an execution of the software application and application components 202. In particular embodiments, the data acquisition engine 204 may be utilized to identify one or more relationships or links (e.g., as illustrated by the solid arrows between the software application and application components 202) between each of the authentication component 217, the user portal component 218, the activity component 219, the secure documentation component 220, the one or more third-party or ancillary application components 221, and/or the validator component 222.

For example, in one embodiment, the authentication component 217 may be identified as being linked to the user portal component 218, the activity component 219, and the one or more third-party or ancillary application components 221. Similarly, in another embodiment, the secure documentation component 220 may be identified as being linked to the user portal component 218 and the validator component 222.

In particular embodiments, the workflow of the integrated software remediation management and deployment system 200A, 200B may then continue with the semantic data representation module 206 receiving from the data acquisition engine 204 the identified relationships and extracting a set of features representative of the runtime environment of the software application and application components 202 based on the identified relationships therebetween. For example, in one embodiment, the semantic data representation module 206 may extract from the identified relationships between the authentication component 217, the user portal component 218, the activity component 219, the secure documentation component 220, the one or more third-party or ancillary application components 221, and/or the validator component 222 a set of features most predictive of the runtime environment of the software application and application components 202.

In particular embodiments, the workflow of the integrated software remediation management and deployment system 200A, 200B may then continue with the feature fusion and aggregator 208 receiving from the semantic data representation module 206 the set of features most predictive of the runtime environment of the software application and application components 202. In one embodiment, the feature fusion and aggregator 208 may be utilized to combine the set of features most predictive of the runtime environment of the software application and application components 202 into a combined feature data set.

For example, in particular embodiments, the feature fusion and aggregator 208 may sort and classify the set of features most predictive of the runtime environment of the software application and application components 202 into one or more sets of labeled data sets 224, 226, 228, and 230. In one embodiment, for example, the sets of labeled data sets 224 and 226 may represent low-level predictive features and the sets of labeled data sets 228 and 230 may represent high-level predictive features. The feature fusion and aggregator 208 may then combine the one or more sets of labeled data sets 224, 226, 228, and 230 into a combined feature data set 232 to be inputted to the neuromorphic dependency analyzer 210.

In particular embodiments, the workflow of the integrated software remediation management and deployment system 200A, 200B may then continue with the neuromorphic dependency analyzer 210 receiving from the feature fusion and aggregator 208 the combined feature data set 232 and executing one or more machine-learning models 234 trained to generate a prediction (via output layer 236) of one or more dependencies 238 of each of the authentication component 217, the user portal component 218, the activity component 219, the secure documentation component 220, the one or more third-party or ancillary application components 221, and/or the validator component 222 with respect to each other.

In one embodiment, the one or more machine-learning models 234 may include, for example, one or more of a neuromorphic image compression (NIC) model or a spiking neural network (SNN). In particular embodiments, the one or more machine-learning models 234 may include a machine-learning model (e.g., one or more SNNs) trained to generate and output (via output layer 236) a sequence of “spikes” or a “spike” train (e.g., a series of neuronal impulses) corresponding to a targeted feature identified within the combined feature data set 232. Specifically, the generated and outputted sequence of “spikes” or “spike” train may correspond to a targeted feature representative of the prediction of the dependencies 238.

In another embodiment, the one or more machine-learning models 234 may include, for example, one or more of an autoencoder (AE), a variational autoencoder (VAE), a generative adversarial network (GAN), a bidirectional generative adversarial network (BiGAN), or other similar machine-learning model that may be suitable for generating one or more predictions of the dependencies 238. In particular embodiments, the one or more machine-learning models 234 may be trained to generate the prediction of the dependencies 238 by generating a prediction of each of the authentication component 217, the user portal component 218, the activity component 219, the secure documentation component 220, the one or more third-party or ancillary application components 221, and/or the validator component 222 likely to experience a downtime during a remediation (e.g., patching) of the software application component on which it depends.

For example, as further depicted by the dependencies 238 in FIGS. 2A and 2B, relationship “R1” illustrates that the user portal component 218 is dependent upon the secure documentation component 220, which is in turn dependent upon the validator component 222. Similarly, relationship “R2” illustrates that the authentication component 217 is dependent upon the activity component 219, which is in turn dependent upon the user portal component 218. In particular embodiments, the workflow of the integrated software remediation management and deployment system 200A, 200B may then continue with the dependency mapping analysis layer 212 receiving the prediction of the dependencies 238.

For example, in particular embodiments, the dependency mapping analysis layer 212 may include a dependency analysis engine 242 and a live dependency clustering and categorization 244 that may be utilized to map and associate the dependencies 238 to one or more remediations (e.g., patches) to be deployed to, for example, one or more of the authentication component 217, the user portal component 218, the activity component 219, the secure documentation component 220, and/or the validator component 222. Specifically, the dependency mapping analysis layer 212 may be utilized to derive and surface one or more insights based on the prediction of the dependencies 238 generated by the one or more machine-learning models 234 to be applied to a prioritization and deployment of the one or more remediations (e.g., patches) under real-time or near real-time application environment conditions.

In particular embodiments, the workflow of the integrated software remediation management and deployment system 200A, 200B may then continue with the patch management system 214 prioritizing, validating, and deploying one or more remediations (e.g., patches). As depicted, in particular embodiments, the patch management system 214 may include a patching orchestrator 246 and a patching request backlog 248 that may be utilized, for example, prioritizing, validating, and deploying remediations (e.g., patches) to one or more of the authentication component 217, the user portal component 218, the activity component 219, the secure documentation component 220, and/or the validator component 222.

In particular embodiments, the patch management system 214 may include a patching request evaluation component 253, a patching request impact scoring component 254, and a patching request prioritization component 256. For example, in one embodiment, the patching request evaluation component 253 may access one or more patching requests 258, 260, 262, and 264 included within the patching request backlog 248 and evaluate the one or more patching requests 258, 260, 262, and 264 in accordance with the insights derived by the dependency mapping analysis layer 212.

In particular embodiments, the patching request impact scoring component 254 may then score each of the one or more patching requests 258, 260, 262, and 264 in accordance with its impact to downtime during a remediation (e.g., patching) one or more of the authentication component 217, the user portal component 218, the activity component 219, the secure documentation component 220, and/or the validator component 222. In particular embodiments, as part of the scoring of the one or more patching requests 258, 260, 262, and 264, the patch management system 214 may execute a simulated deployment of the one or more remediations (e.g., patches) to validate the one or more remediations (e.g., patches) prior to deploying the one or more remediations (e.g., patches) to one or more of the authentication component 217, the user portal component 218, the activity component 219, the secure documentation component 220, and/or the validator component 222.

For example, in one embodiment, the patch management system 214 may execute a canary deployment of the one or more remediations (e.g., patches), in which the one or more remediations (e.g., patches) may be deployed first to the one or more software application components having the lowest impact scores and lowest remediation time periods followed by the one or more software application components having the highest impact scores and highest remediation time periods under real-time or near real-time application environment conditions.

In particular embodiments, the patching request prioritization component 256 may then prioritized the one or more patching requests 258, 260, 262, and 264 based on their respective impact scores, and the patch management system 214 may then dynamically update the patching request backlog 248 and generate the updated patching request backlog 252. For example, as depicted by the updated patching request backlog 252, the patch management system 214 may dynamically update the patching request backlog 248 to indicate dependent software application components associated with the time periods (e.g., patching requests 262, 264 at “30 minutes,” patching request 260 at “2.5 hours,” patching request 258 at “8 hours,” and so forth) for executing and completing the associated remediation (e.g., patching).

In particular embodiments, upon validating the one or more remediations (e.g., patches) under real-time or near real-time application environment conditions via the simulated deployment of the one or more remediations (e.g., patches), the patch management system 214 may then execute an actual deployment of the one or more remediations (e.g., patches). In particular embodiments, the patch management system 214 may further direct network traffic away from the one or more other software application components undergoing the one or more remediations (e.g., patches).

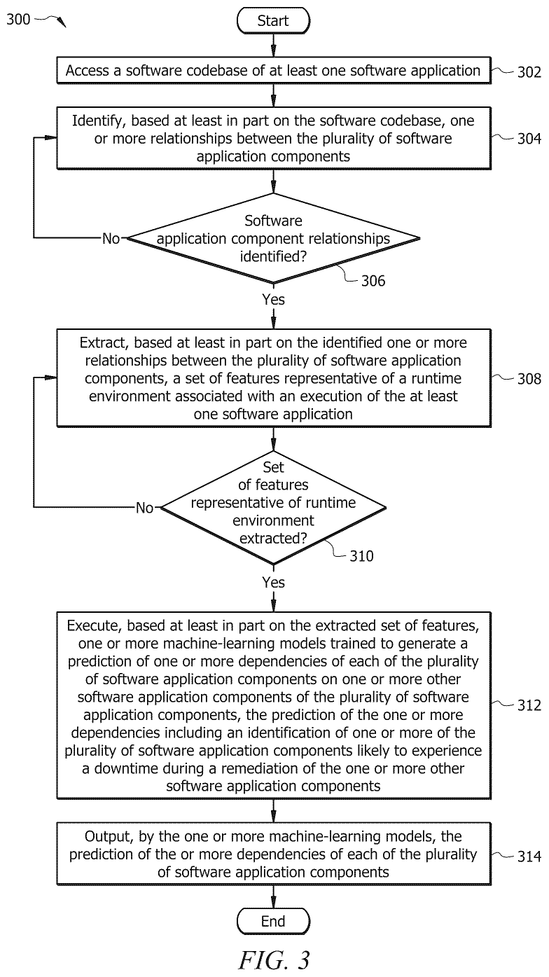

FIG. 3 illustrates a flowchart of an example method 300 for predicting dependency patterns and behaviors of software applications to optimize code remediation, in accordance with one or more embodiments of the present disclosure. The method 300 may be performed utilizing the one or more processors 102 as described above with respect to FIG. 1. The method 300 may begin at block 302 with the one or more processors 102 accessing a software codebase of at least one software application. For example, in one embodiment, the one or more processors 102 may access a software codebase that may be associated with the software application and application components 202.

In particular embodiments, the method 300 may then continue at block 304 with the one or more processors 102 identifying, based at least in part on the software codebase, one or more relationships between the plurality of software application components. For example, in one embodiment, the one or more processors 102 may identify one or more relationships or links between each of the software application and application components 202. In particular embodiments, the method 300 may continue at decision 306 with the one or more processors 102 confirming whether the one or more relationships or links between each of the software application and application components 202 has been identified.

In particular embodiments, in response to confirming that the one or more relationships or links between each of the software application and application components 202 has not been identified (e.g., at decision 306), the method 300 may return to block 304. On the other hand, in response to confirming that the one or more relationships or links between each of the software application and application components 202 has been identified (e.g., at decision 306), the method 300 may continue at block 308 with the one or more processors 102 extracting, based at least in part on the identified one or more relationships between the plurality of software application components, a set of features representative of a runtime environment associated with an execution of the at least one software application.

For example, in particular embodiments, the one or more processors 102 may extract a set of features representative of the runtime environment of the software application and application components 202 based on the identified relationships therebetween. In particular embodiments, the method 300 may continue at decision 310 with the one or more processors 102 confirming whether the set of features representative of the runtime environment of the software application and application components 202 has been extracted. In particular embodiments, in response to confirming that the set of features representative of the runtime environment of the software application and application components 202 has not been extracted (e.g., at decision 310), the method 300 may return to block 308.

On the other hand, in response to confirming that the set of features representative of the runtime environment of the software application and application components 202 has been extracted (e.g., at decision 310), the method 300 may continue at block 312 with the one or more processors 102 executing, based at least in part on the extracted set of features, one or more machine-learning models trained to generate a prediction of one or more dependencies of each of the plurality of software application components on one or more other software application components of the plurality of software application components.

For example, in particular embodiments, the one or more processors 102 may execute one or more machine-learning models 234 trained to generate a prediction of one or more dependencies 238 of each of the software application and application components 202. In particular embodiments, the method 300 may then conclude at block 314 with the one or more processors 102 outputting, by the one or more machine-learning models, the prediction of the or more dependencies of each of the plurality of software application components.

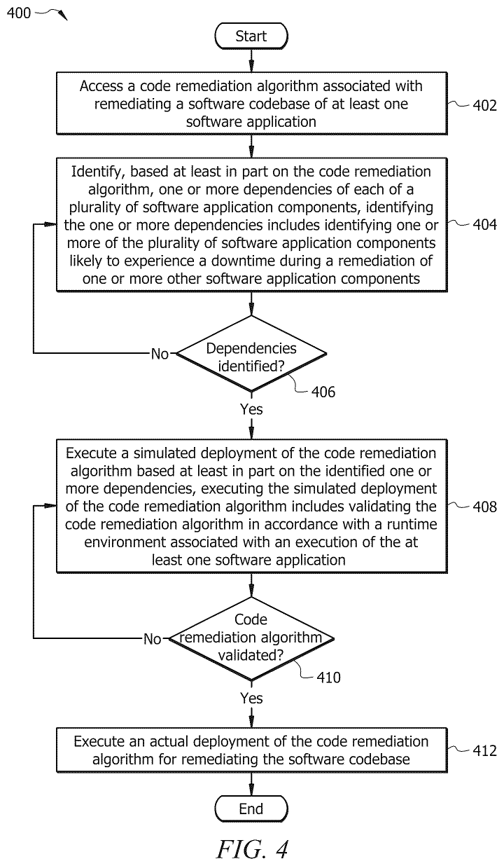

FIG. 4 illustrates a flowchart of an example method 400 for dynamically updating code remediation workflows based on dependency patterns and behaviors of software applications, in accordance with one or more embodiments of the present disclosure. The method 400 may be performed utilizing the one or more processors 103 as described above with respect to FIG. 1. The method 400 may begin at block 402 with the one or more processors 103 accessing a code remediation algorithm associated with remediating a software codebase of at least one software application. For example, in one embodiment, the one or more processors 103 may access the software code remediation algorithm 111.

In particular embodiments, the method 400 may then continue at block 404 with the one or more processors 103 identifying, based at least in part on the code remediation algorithm, one or more dependencies of each of a plurality of software application components, in which identifying the one or more dependencies includes identifying one or more of the plurality of software application components likely to experience a downtime during a remediation of one or more other software application components. In particular embodiments, the method 400 may continue at decision 406 with the one or more processors 103 confirming whether the one or more dependencies has been identified. In particular embodiments, in response to confirming that the one or more dependencies 238 has not been identified (e.g., at decision 406), the method 400 may return to block 404.

On the other hand, in response to confirming that the one or more dependencies 238 has been identified (e.g., at decision 406), the method 400 may continue at block 408 with the one or more processors 103 executing a simulated deployment of the code remediation algorithm based at least in part on the identified one or more dependencies, in which executing the simulated deployment of the code remediation algorithm includes validating the code remediation algorithm in accordance with a runtime environment associated with an execution of the at least one software application.

For example, in particular embodiments, the one or more processors 103 may then execute a simulated deployment of the code remediation algorithm 111 to validate the code remediation algorithm 111 prior to deploying the code remediation algorithm 111 to one or more of the software application and application components 202. In particular embodiments, the method 400 may continue at decision 410 with the one or more processors 103 confirming whether the code remediation algorithm 111 has been validated.

In particular embodiments, in response to confirming that the code remediation algorithm 111 has not been validated (e.g., at decision 410), the method 400 may return to block 408. On the other hand, in response to confirming that the code remediation algorithm 111 has been validated (e.g., at decision 310), the method 400 may then conclude at block 412 with the one or more processors 102 executing an actual deployment of the code remediation algorithm 111 for remediating one or more of the software application and application components 202.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a software codebase of at least one software application, wherein the at least one software application comprises a plurality of software application components; and
one or more processors operably coupled to the memory and configured to:
access the software codebase of the at least one software application;
identify, based at least in part on the software codebase, one or more relationships between the plurality of software application components;
extract, based at least in part on the identified one or more relationships between the plurality of software application components, a set of features representative of a runtime environment associated with an execution of the at least one software application;
execute, based at least in part on the extracted set of features, one or more machine-learning models trained to generate a prediction of one or more dependencies of each of the plurality of software application components on one or more other software application components of the plurality of software application components, wherein the prediction of the one or more dependencies comprises an identification of one or more of the plurality of software application components likely to experience a downtime during a remediation of the one or more other software application components; and
output, by the one or more machine-learning models, the prediction of the one or more dependencies of each of the plurality of software application components.

2. The system of claim 1, wherein the one or more machine-learning models comprises one or more of a neuromorphic image compression (NIC) model, a spiking neural network (SNN), an autoencoder (AE), a variational autoencoder (VAE), a generative adversarial network (GAN), or a bidirectional generative adversarial network (BiGAN).

3. The system of claim 1, wherein the one or more processors are further configured to identify the one or more relationships between the plurality of software application components by receiving a real-time or near real-time data stream during the execution of the at least one software application.

4. The system of claim 1, wherein the one or more processors are further configured to extract a set of most predictive features representative of the runtime environment associated with the execution of the at least one software application.

5. The system of claim 4, wherein the one or more processors are further configured to:
prior to executing the one or more machine-learning models, combine the set of most predictive features representative of the runtime environment into a combined feature data set for input to the one or more machine-learning models.

6. The system of claim 5, wherein the one or more processors are further configured to execute the one or more machine-learning models further trained to generate the prediction of the one or more dependencies based at least in part on the combined feature data set.

7. The system of claim 1, wherein the plurality of software application components comprises one or more of a user portal component, a validator component, an activity component, an authentication component, a secure documentation component, or a third-party application component.

8. A method, comprising:
accessing a software codebase of at least one software application;
identifying, based at least in part on the software codebase, one or more relationships between a plurality of software application components of the at least one software application;
extracting, based at least in part on the identified one or more relationships between the plurality of software application components, a set of features representative of a runtime environment associated with an execution of the at least one software application;
executing, based at least in part on the extracted set of features, one or more machine-learning models trained to generate a prediction of one or more dependencies of each of the plurality of software application components on one or more other software application components of the plurality of software application components, wherein the prediction of the one or more dependencies comprises an identification of one or more of the plurality of software application components likely to experience a downtime during a remediation of the one or more other software application components; and
outputting, by the one or more machine-learning models, the prediction of the one or more dependencies of each of the plurality of software application components.

9. The method of claim 8, wherein the one or more machine-learning models comprises one or more of a neuromorphic image compression (NIC) model, a spiking neural network (SNN), an autoencoder (AE), a variational autoencoder (VAE), a generative adversarial network (GAN), or a bidirectional generative adversarial network (BiGAN).

10. The method of claim 8, wherein identifying the one or more relationships between the plurality of software application components comprises receiving a real-time or near real-time data stream during the execution of the at least one software application.

11. The method of claim 8, further comprising extracting a set of most predictive features representative of the runtime environment associated with the execution of the at least one software application.

12. The method of claim 11, further comprising prior to executing the one or more machine-learning models, combining the set of most predictive features representative of the runtime environment into a combined feature data set for input to the one or more machine-learning models.

13. The method of claim 12, further comprising executing the one or more machine-learning models further trained to generate the prediction of the one or more dependencies based at least in part on the combined feature data set.

14. The method of claim 8, wherein the plurality of software application components comprises one or more of a user portal component, a validator component, an activity component, an authentication component, a secure documentation component, or a third-party application component.

15. A non-transitory computer-readable medium storing instructions that, when executed by one or more processors, cause the one or more processors to:
access a software codebase of at least one software application;
identify, based at least in part on the software codebase, one or more relationships between a plurality of software application components of the at least one software application;
extract, based at least in part on the identified one or more relationships between the plurality of software application components, a set of features representative of a runtime environment associated with an execution of the at least one software application;
execute, based at least in part on the extracted set of features, one or more machine-learning models trained to generate a prediction of one or more dependencies of each of the plurality of software application components on one or more other software application components of the plurality of software application components, wherein the prediction of the one or more dependencies comprises an identification of one or more of the plurality of software application components likely to experience a downtime during a remediation of the one or more other software application components; and
output, by the one or more machine-learning models, the prediction of the one or more dependencies of each of the plurality of software application components.

16. The non-transitory computer-readable medium of claim 15, wherein the one or more machine-learning models comprises one or more of a neuromorphic image compression (NIC) model, a spiking neural network (SNN), an autoencoder (AE), a variational autoencoder (VAE), a generative adversarial network (GAN), or a bidirectional generative adversarial network (BiGAN).

17. The non-transitory computer-readable medium of claim 15, wherein the instructions further cause the one or more processors to identify the one or more relationships between the plurality of software application components by receiving a real-time or near real-time data stream during the execution of the at least one software application.

18. The non-transitory computer-readable medium of claim 15, wherein the instructions further cause the one or more processors to extract a set of most predictive features representative of the runtime environment associated with the execution of the at least one software application.

19. The non-transitory computer-readable medium of claim 18, wherein the instructions further cause the one or more processors to:
prior to executing the one or more machine-learning models, combine the set of most predictive features representative of the runtime environment into a combined feature data set for input to the one or more machine-learning models.

20. The non-transitory computer-readable medium of claim 19, wherein the instructions further cause the one or more processors to generate the prediction of the one or more dependencies based at least in part on the combined feature data set.
